(19) United States
(12) Patent Application Publication
(10) Pub. No.: US 2023/0098165 A1
(43) Pub. Date: Mar. 30, 2023

(54) SMART ALERT CORRELATION FOR CLOUD SERVICES

(71) Applicant: Microsoft Technology Licensing, LLC, Redmond, WA (US)

(72) Inventors: Tianjun SHI, Sammamish, WA (US); Navendu JAIN, Snohomish, WA (US); Binu K. PURAYIL, Renton, WA (US); Yuanfang SUN, Bellevue, WA (US); Neeraj ESWARAN, Sammamish, WA (US); Xiaoxiao JIANG, Bellevue, WA (US); Zhangwei XU, Redmond, WA (US)

(21) Appl. No.: 17/486,389

(22) Filed: Sep. 27, 2021

(51) Int. Cl. H04L 12/24

(52) U.S. Cl. CPC H04L 41/0631; H04L 41/16; H04L 41/0686; H04L 67/10

(57) ABSTRACT

Methods and systems described herein correlate an incoming alert, regarding events that affect service performance, availability, and security in a cloud services platform, with an existing incident record, stored in remote storage, to enable improved incident handling. Alert information is applied to machine-learning models to correlate the incoming alert to a parent incident record. In rule-based correlation, a local cache stores query signatures (keys) and information related to respective incident records (values). A correlation rule is retrieved for the alert, and a correlation query is constructed based on the alert and the rule. A query signature is generated and used as a cache key to access information about a respective parent incident in storage. If the parent information is not found in the cache, the remote storage is searched for the parent incident record using the correlation query. The alert and correlated parent incident record are associated in remote storage.

### BACKGROUND

The practice of event monitoring is pervasive in cloud services. Users are often alerted regarding events that affect service performance, availability, and security. However, excessive alerting may cause alert fatigue for the engineers handling the alerts. For example, a high volume of alerts may be issued in a system where most, or many of them, are non-actionable. Such comprehensive alerting may overwhelm the engineers thereby risking adverse system impacts (e.g., impaired service performance, inoperable software and/or hardware, unaddressed security breaches, or the like) and poor customer support where important events either go unnoticed or have a delayed problem resolution. An on-call engineer is often faced with determining whether a newly received alert is related to an existing issue (i.e., existing incident record) that's already being worked on, or a whether the new alert pertains to a new issue that should be opened in their incident record system.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, apparatuses, and computer-readable storage media described herein are provided for correlating an event with an existing event record based on machine-learning correlation models. The system may comprise one or more processors, event memory storing information related to a plurality of existing event records, and one or more memory devices storing program code to be executed by the one or more processors. The program code may comprise a machine-learning-based correlation engine configured to receive information related to the event and input the information related to the event to one or more machine-learning models. Each of the one or more machine-learning models may be configured to determine whether the event is correlated to an existing event record of the plurality of existing event records. Based on output from each of the one or more machine-learning models, the program code may be further configured to generate a machine-learning-based correlation result indicating that a correlation exists between the event and a first existing event record of the plurality of existing event records. Based on at least the machine-learning-based correlation result, the program code may be further configured to store information in the event memory indicating that the event is correlated to the first existing event record.

Methods, systems, apparatuses, and computer-readable storage media described herein are provided for rule-based correlation of an event with an existing event record. The system comprises one or more processors, memory local to the one or more processors. The local memory may comprise a cache storing a plurality of cache entries. Each cache entry in the plurality of cache entries may include (i) information related to a respective existing event record wherein the related information is retrieved from a database remote to the one or more processors, and (ii) a respective signature of a correlation query, the correlation query for retrieving the information related to the respective existing event record from the remote database. The system may further include program code comprising a rule-based correlation engine configured to receive information about a first event, retrieve an event matching correlation rule based on the information about the first event, and construct a first correlation query based on the information about the first event and the event matching correlation rule. The rule-based correlation engine may be further configured to generate a first signature based on, at least, the first correlation query, identify a first cache entry in the cache based on the first signature, associate the first event with an existing event record about which related information is stored in the first cache entry, and store an indication of the association between the first event and the existing event record (about which the related information is stored in the first cache entry) in the remote database.

Further features and advantages of embodiments, as well as the structure and operation of various embodiments, are described in detail below with reference to the accompanying drawings. It is noted that the methods and systems are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1A is a block diagram of a system for correlating a received alert with an existing incident record utilizing rule-based and/or machine-learning-based techniques, according to an example embodiment.

FIG. 1B is a block diagram comprising a detail of example cache entries of the cache memory shown in FIG. 1A, according to an example embodiment.

FIG. 2 is a flowchart of a method for correlating an alert with an existing incident record utilizing one or more machine learning models, according to an example embodiment.

FIG. 3 is a flowchart of a method for rule-based correlation of an alert with an existing incident record, according to an example embodiment.

FIG. 4 is a flowchart of a method for correlating an alert with an existing incident record utilizing a combination of rule-based and machine-learning-based correlation techniques, according to an example embodiment.

FIG. 5 is a flowchart of an example method for correlating a received alert with an existing incident record utilizing rule-based or machine-learning-based correlation techniques, according to an example embodiment.

FIG. 6 is a block diagram of an example processor-based computer system that may be used to implement various embodiments.

The features and advantages of the embodiments described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

As described above, monitoring of cloud services may include alerting on events that can have an impact on service performance, availability, and security for users. However, in a high volume of issued alerts, many or most of them may not be actionable, which may overwhelm engineers that are tasked with handling them. Such a situation may lead to important events going unnoticed or poor response times, which can in turn lead to significant technical problems including, but not limited, impaired service performance, inoperable software and/or hardware, and/or unaddressed security breaches. An initial task in handling a received alert (e.g., a newly received alert) may be to correlate the alert with an existing incident record, which may already be open in the system. In this regard, an issue in the existing incident record may be investigated and/or resolved together with issue indicated in the received alert, otherwise a new incident record may be opened for the received alert if the received alert represents a new problem (e.g., is not correlated with an existing incident record). In other words, if a correlated existing incident record is found in the system, the received alert may be associated with it in the system, otherwise a new incident record may be created for the received alert.

In some computer systems (e.g., a cloud service system), an alert processing pipeline may be set up to handle the incoming alerts. One task of this pipeline may be to correlate each alert to a corresponding existing incident record. A rule-based correlation system may be deployed that performs two phases of matching: (1) find a matching correlation rule for the given alert from a manually defined set of correlation rules based on information in the alert. If such a correlation rule is found, (2) find a related existing incident based on matching criteria defined by the correlation rule. Both phases of matching may include queries against remote storage such as a structure query language (SQL) server. Given a high volume of alerts, the number of queries against the remote storage per unit time may be very high and that may put substantial pressure on storage operations.

Systems and methods are provided herein for correlating alerts with existing incident records and storing indications of associations of the alerts and the correlated existing incident records. First, a cache-based correlation framework may utilize fingerprint signatures of correlation queries (i.e., query signatures) to function as keys to access cache entries in a rule-based correlation technique. In some embodiments, the cache entries may comprise a key-value store (i.e., a key-value database). A key-value store may comprise a data structure or an associative array storing a collection of cache entries in the cache, where each entry comprises a key (e.g., a query signature) and an associated value (e.g., information related to an existing incident record). When a query is made to a remote database (e.g., for an existing incident record), information (e.g., an incident ID) from query results received from the remote database may be stored as a value in a cache entry, and a query signature of the query may be stored as a key or index to the cache entry. The query signature may then be utilized to retrieve or store information (e.g., a value) in the cache entry. The key (or query signature) may uniquely identify a respective cache entry (e.g., stored information or value related to an existing incident record). In some embodiments, the stored values in cache entries may have different fields within them. The validity of a cache entry may be calculated based on a correlation window and an age of the cached existing incident information. Rule based correlation of alerts and existing incidents is described in more detail below.

Alternatively, or in addition, one or both of supervised and unsupervised machine-learning-based correlation techniques may be utilized for correlating alerts with corresponding existing incident records. The combination of these machine-learning-based techniques may improve (e.g., maximize) recall. With supervised machine-learning-based correlation, a predictive model may be learned from historical correlated alerts. An unsupervised machine-learning-based framework may be used to automatically learn correlation signatures. More specifically, frequent-pattern and sequential pattern mining may be performed using historical alert data to learn co-occurrence of alerts and dependency information. This data-driven approach may eliminate the need to define manual rules for a broad range of operational scenarios. The machine learning process may output machine learning models that may be configured to match new alerts with existing incident records and provide confidence scores. These confidence scores may be tuned in a data-driven manner to balance fundamental precision vs. recall tradeoffs.

Moreover, a hybrid rule-based and machine-learning-based system may be configured to apply these techniques in tandem to improve (e.g., maximize) the benefits while allowing flexibility in the ordering of the two techniques. In one example, for systems with a mature, stable set of rules, the rules-based correlation may be applied first before machine-learning-based approaches to improve (e.g., maximize) recall. In another example, for systems with new onboarding services or old services evolving with legacy rules, the machine learning system may be applied first to provide high precision and high recall, with rules-based correlation used only to handle corner cases, or for bootstrapping. Further example alert correlation flows are described in more detail below.

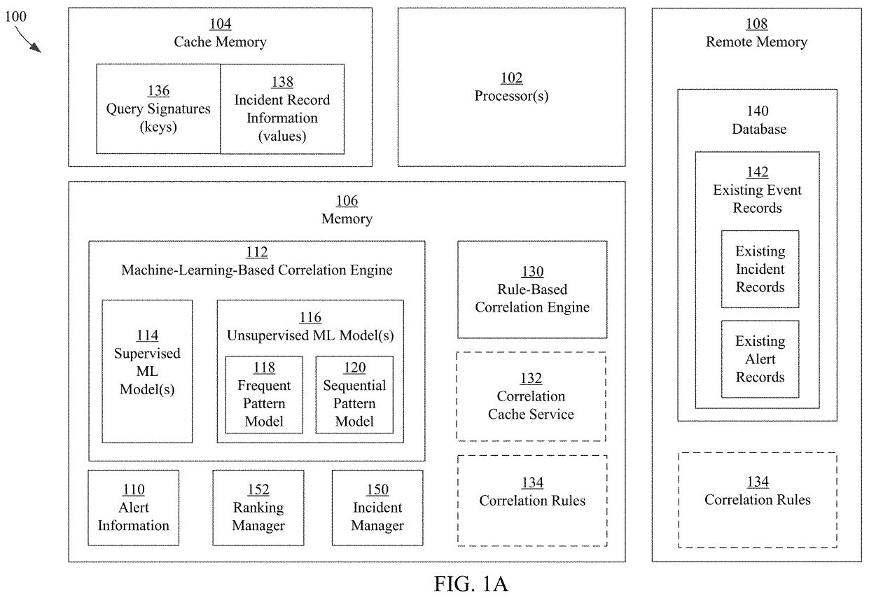

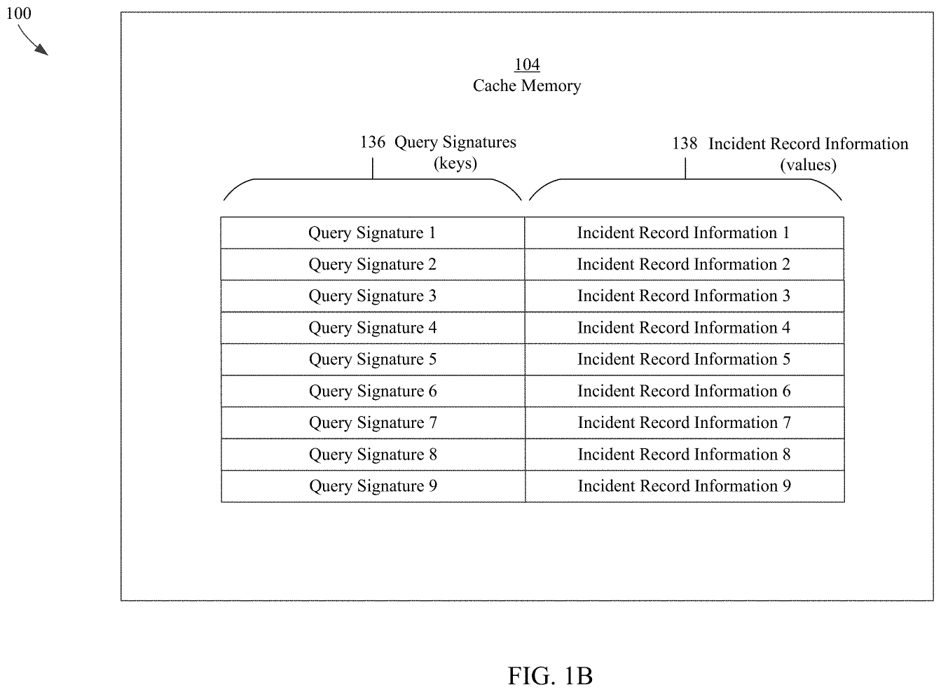

Embodiments for correlating newly received alerts with existing incident records may be implemented and may operate in various ways. Such embodiments are described as follows. For instance, FIG. 1A is a block diagram of a system 100 for correlating a received alert with an existing incident record utilizing rule-based and/or machine-learning-based techniques, according to an example embodiment. As shown in FIG. 1A, system 100 includes one or more processors 102, a memory 104, a memory 106, and memory 108. Memory 106 may store alert information 110, a machine-learning-based correlation engine 112, a rule-based correlation engine 130, a correlation search service 132, correlation rules 134, an incident manager 150, and a ranking manager 152. Machine-learning-based correlation engine 112 may comprise one or more supervised machine learning models 114 and one or more unsupervised machine learning models 116. Unsupervised machine learning model(s) 116 may store a frequent pattern model 118 and a sequential pattern model 120. Memory 108 may store a database 140 that stores a plurality of existing event records 142. In some embodiments, memory 108 may store correlation rules 134. These features of system 100 are described in further detail as follows. FIG. 1B is a block diagram comprising a detail of the cache entries of cache memory 104 shown in FIG. 1A, according to an example embodiment. As shown in FIG. 1B, cache memory 104 stores a plurality of query signatures 136 (e.g., keys) and a corresponding plurality of records comprising respective incident record information 183 records (values).

In some embodiments, an event may comprise an alert and may be referred to as an alert, and an existing event record may comprise an existing incident record and may be referred to as an existing incident record.

In some embodiments, an event or information related to an event may obtained from an alert record, and an existing event record may comprise an existing alert record. A first alert record may be correlated with the second alert record. An alert record may be modified or enriched with additional information over time.

In some embodiments, an event or information related to an event may be obtained from an incident record, and an existing event record may comprise an existing incident record. A first incident record may be correlated with the second incident record. An incident record may be modified or enriched with additional information over time.

In some embodiments, correlation of an event to an existing event record is triggered by a new event. In some embodiments, correlation of an event to an existing event record of a plurality of existing event records is repeated over time.

In some embodiments, information related to an event is enriched (or modified) between a first correlation of the event and a second correlation of the event.

In some embodiments, system 100 may comprise an incident management system or a portion of an incident management system, which receives alerts (e.g., events) from one or more monitoring agents in one or more source systems (e.g., a server environment hosting customer services). The monitoring agents may track telemetry signals of various resources of the source system (e.g., hardware resources, applications, security resources, etc.). An alert may be generated by a monitoring agent when an alert condition is detected in the telemetry information, and the alert may be communicated to system 100.

Processor(s) 102 may include any suitable number of processors, which may include, for example, central processing units (CPUs), microprocessors, multi-processors, processing cores, and/or any other hardware-based processor types described herein or otherwise known. Processors(s) 102 may be implemented in any type of mobile or stationary computing device. Examples of mobile computing devices include but are not limited to a Microsoft® Surface® device, a personal digital assistant (PDA), a laptop computer, a notebook computer, a tablet computer such as an Apple iPad™, a netbook, a smart phone (such as an Apple iPhone, a phone implementing the Google® Android™ operating system), a wearable computing device (e.g., a head-mounted device including smart glasses such as Google® Glass™, or a virtual headset such as Oculus Rift® by Oculus VR, LLC or HoloLens® by Microsoft Corporation). Examples of stationary computing devices include but are not limited to a desktop computer or PC (personal computer), a server computer (e.g., a headless server), or a gaming console. Processor(s) 102 may run any suitable type of operating system, including, for example, Microsoft Windows®, Apple Mac OS® X, Google Android™, and Linux®.

Memory 104, memory 106, and memory 108 may comprise one or more memory devices, which may include any suitable type(s) of physical storage mechanism, including, for example, magnetic disc (e.g., in a hard disk drive), optical disc (e.g., in an optical disk drive), solid-state drive (SSD), a RAM (random access memory) device, a ROM (read only memory) device, and/or any other suitable type of physical, hardware-based storage medium.

In some embodiments, memory 104 may comprise a cache memory and may be referred to as cache memory 104, cache 104, or local memory 104. Cache memory 104 may comprise memory on or separate from processor(s) 102 or may be part of memory 106. In one example, cache memory 104 may comprise a smaller, faster memory located closer to processor(s) 102 that may operate faster than a main memory for the processor.

In some embodiments, memory 106 may comprise a main memory for processor(s) 102 and may be referred to as main memory 106. For example, main memory 106 may comprise RAM memory for storing program instructions and/or data processed by processor(s) 102. Although the elements shown in memory 106 are shown as separate elements, some of the elements may be combined to form a single element, or some of the elements may be divided into multiple separate elements. For example, machine-learning-based correlation engine 112 and rule-based correlation engine 130 are shown as two separate correlation engines in system 100, however, in some embodiments, machine-learning-based correlation engine 112 and rule-based correlation engine 130 may be consolidated into a single unified correlation engine that may perform the functions of both of the separate correlation engines 112 and 130.

In some embodiments, memory 108 may comprise a remote storage for processor(s) 102. Memory 108 may be referred to as remote memory 108, remote storage 108, event memory 108, alert memory 108, or incident memory 108. Remote storage 108 may comprise non-volatile memory for long term persistent storage. For example, remote storage 108 may store database 140, which may be referred to as remote database 140. Database 140 may store database existing event records 142, which may comprise existing incident records and/or existing alert records. Existing event records 142 may be referred to as existing incident records 142 or referred to as existing alert records 142. However, each of memory 104, memory 106, and memory 108 is not limited to being any specific type of memory, and any type(s) of memory devices suitable for use in the present disclosure may be utilized to implement these memories.

Database 140 may store a plurality of existing event records 142 (e.g., existing incident records 142 and/or existing alert records 142). Each existing incident record 142 may include information related to one or more previously received alerts, for example, one or more alert attributes or alert metadata. In some embodiments, an existing incident record 142 may store information pertaining to one or more issues or problems occurring in a monitored system and/or related issue resolution information. The issue or problem may relate to one or more received alerts (i.e., events). Existing incident records 142 may be utilized by users (e.g., an engineer or administrator) as issues are worked on or evolve over time. Existing incident records 142 may be modified or enriched based on additional or new related alerts or information input by users (e.g., information related to issue resolution or issue status). Existing event records for alerts (e.g., existing alert records 142) may each comprise information about one or more received alerts (e.g., an alert log). Existing alert records 142 may also be modified or enriched over time by users and/or system 100.

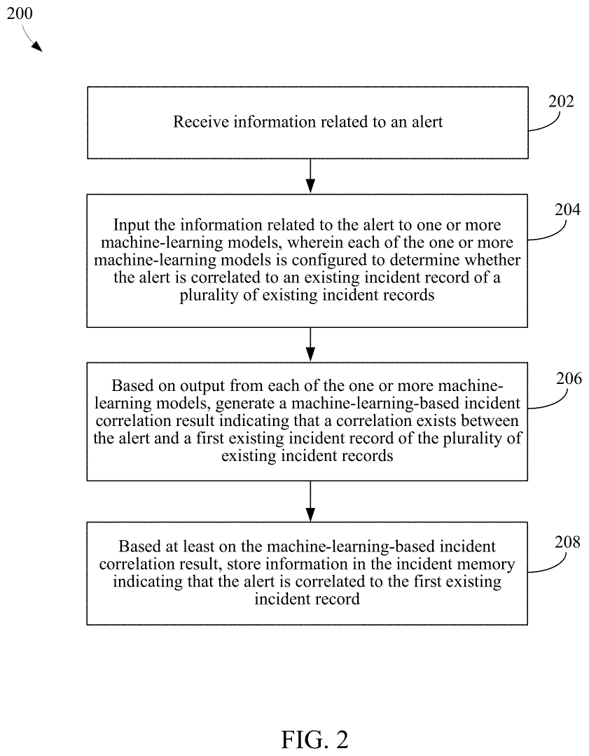

The following flowcharts of FIGS. 2-5 describe various embodiments for correlating an alert (i.e., an event) with an existing incident record (i.e., an existing event record). However, a person skilled in the relevant arts would understand that the machine-learning based correlation techniques and/or the rule-based correlation techniques described herein may also be applied to (i) correlating an incoming alert with an existing alert record (e.g., stored in existing event records 142), (ii) correlating a first existing alert record with a second existing alert record, or (iii) correlating a first existing incident record (e.g., stored in existing event records 142), with a second existing incident record.

FIG. 2 is a flowchart 200 of a method for correlating an alert with an existing incident record utilizing one or more machine learning models, according to an example embodiment. The method of flowchart 200 may be implemented in system 100. For purposes of illustration, flowchart 200 is described with reference to FIG. 1. As shown in FIG. 1, memory 106 may comprise machine-learning-based correlation engine 112, which may comprise supervised learning model(s) 114 and/or unsupervised machine-learning model(s) 116. Other structural and operational embodiments will be apparent to persons skilled in the relevant art(s) based on the following discussion regarding flowchart 200 and FIG. 1.

Flowchart 200 of FIG. 2 begins with step 202. In step 202, information related to an alert may be received. The alert information may pertain to an alert stored in, for example, database 140, or in another memory location, and/or the alert information may pertain to a newly received alert. For example, processor(s) 102 may be configured to receive alerts for events that occur in a monitored system (e.g., a source system). The alerts may communicate issues or problems in the source system that may be customer affecting and/or may have an impact on service performance, availability, and/or security. Example alerts may comprise hardware alerts, application alerts, security alerts, etc. Machine-learning-based correlation engine 112 may be configured to receive alert information 110 that may correspond to an alert received by processor(s) 102. Alert information 110 may comprise alert attributes (or alert metadata) such as an alert identifier (ID), a time associated with the alert, an ID associated with a source of the alert (e.g., hardware and/or software), a create date of the source, an owner of the source, a problem ID, an ID of a problem source device, an ID of a reporting device, an environment or datacenter identifier where a problem occurred, a root cause indication, an incident ID, a parent incident ID, a security impact indicator, a severity level, a customer ID, etc.

In step 204, the information related to the alert may be input to one or more machine-learning models, where each of the one or more machine-learning models is configured to determine whether the alert is correlated to an existing incident record of a plurality of existing incident records. For example, machine-learning-based correlation engine 112 may be configured to input alert information 110 (of a received alert) to supervised machine-learning model(s) 114 and/or unsupervised machine learning model(s) 116. Supervised machine-learning model(s) 114 may be configured to perform a correlation of the received alert with one or more of the plurality of existing incident records 142. Supervised machine-learning model(s) 114 may comprise predictive models that may be trained based on past alert information and known correlated (e.g., positively or negatively correlated) incident records as input. In this regard, the correlated incident records may include information (e.g., attributes or metadata) of previously received related alerts. The trained supervised machine-learning model(s) 114 may be configured to predict whether a newly received alert (or received alert information) is correlated with one or more of the plurality of existing incident records 142. The one or more correlated existing incident records may be referred to as correlation candidates.

In unsupervised machine-learning alert correlation, data mining techniques may be utilized to learn correlation patterns based on historical alerts. Data mining techniques such as frequent pattern and sequential pattern techniques may be utilized to learn the alert correlation patterns. In one example, the correlation of an incoming alert, having alert information 110, to one or more of the plurality of existing incident records 142 may be based on a frequent pattern algorithm that learns frequently co-occurring alerts and generates frequent pattern model 118. The frequent pattern model 118 may output a frequent alert list (i.e., alert fingerprint group) that may include confidence scores for the co-occurring alerts. For example, groups of past alert data may be applied to frequent pattern model 118, which may output the frequent alert list. Machine-learning-based correlation engine 112 may be configured to store the frequent alert list in a frequent pattern look-up table. At prediction time, machine-learning-based correlation engine 112 may perform a lookup operation to this frequent pattern lookup table to find co-occurring alerts for the received alert. The look-up operation may be performed using a key that is based on alert information 110 (e.g., one or more attributes or metadata) of the received alert. If co-occurring alert(s) are found in the frequent pattern look-up table, machine-learning-based correlation engine 112 may perform a search of the plurality of existing incident records 142 to find one or more correlated existing incidents that are associated with one or more of the co-occurring alert(s). The one or more correlated existing incident records found in the search may be referred to as correlation candidates.

In another example, the correlation of incoming alerts with one or more of the plurality of existing incident records 142 may be based on a sequential pattern algorithm. In this technique, the sequential pattern algorithm may output sequential pattern model 120. Sequential pattern model 120 may be trained based on historical alert data and may output a sequence of co-occurring alert dimensions. The alert dimensions may be based on alert attributes or metadata. Machine-learning-based correlation engine 112 may be configured to store these sequential patterns in a sequential pattern lookup table for faster searching. This sequential pattern lookup table may include confidence scores for each of the sequential patterns. At prediction time, machine-learning-based correlation engine 112 may be configured to perform a look up to this sequential pattern table to find any sequential patterns that apply to alert information 110 of the received alert. If a matching sequential pattern is found in the sequential pattern lookup table, machine-learning-based correlation engine 112 may be configured to perform a search of the plurality of existing incident records 142 to find one or more correlated existing incidents with matching sequential patterns. The one or more correlated existing incident records found in the search may be referred to as correlation candidates. In some embodiments, the information stored in the frequent pattern lookup table and the information stored in the sequential pattern lookup table may be combined in a single lookup table for faster lookup operations.

In step 206, based on output from each of the one or more machine-learning models, a machine-learning-based correlation result may be generated, which may indicate that a correlation exists between the alert and a first existing incident record of the plurality of existing incident records. For example, ranking manager 152 may be configured to receive one or more correlation candidates from machine-learning-based correlation engine 112 (e.g., from supervised machine learning model(s) 114 and/or unsupervised machine learning model(s) 116 that may be based on frequent pattern and/or sequential pattern techniques). Ranking manager 152 may be configured to aggregate and rank the existing incident records that are correlation candidates, and select a first existing incident record of the candidates as being correlated with the received alert. In some embodiments, the selection may be based on meeting a criteria for confidence levels associated with each respective correlation candidate (e.g., prediction confidence levels). In some embodiments, the selection of the first existing incident record of the candidates may be based on ranking the correlation candidates with respect to diverse criteria such as (i) a time difference between events (e.g., between an event of the alert and an event of an existing incident record), (ii) matching meta-data (e.g., same source cloud service identifiers, same engineer team name, same location (e.g., based on geo-location), (iii) model confidence scores, (iv) severity levels, (v) state of an incident. However, the criteria used for ranking correlation candidates is not limited to any specific criteria and any suitable criteria or criterion may be utilized. Ranking manager 152 may be configured to generate the machine-learning-based correlation result indicating that a correlation exists between the received alert having alert information 110 and the first existing incident record of the plurality of existing incident records 142.

A correlated existing incident record found in the plurality of existing incident records 142 may be referred to as a parent incident to the received alert (or alert information 110). For example, the selected first existing incident record may be referred to as a parent incident to the alert corresponding to alert information 110.

In step 208, at least based on the machine-learning-based correlation result, information may be stored in the incident memory indicating that the alert is correlated to the first existing incident record. For example, incident manager 150 may be configured to store in memory (e.g., in database 140) an indication that the received alert corresponding to alert information 110 is correlated to the first existing incident record.

In some embodiments, incident manager 150 may be configured to create a new incident record (or object) based on the received alert information 110, and in instances where the first correlated existing incident record is selected as a parent incident to the alert, the new incident may be linked as a child to the selected first correlated existing incident record. Alternatively, or in addition, for example where machine-learning-based correlation engine 112 does not find a correlated existing incident, the newly created incident record may be activated as a primary incident and stored in remote storage 108 as an existing incident.

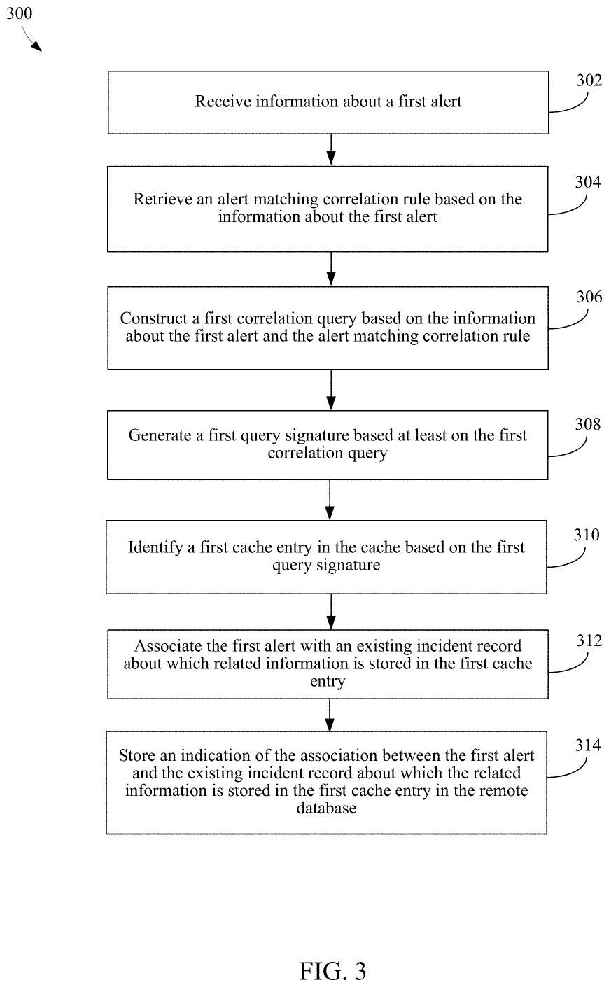

FIG. 3 is a flowchart 300 of a method for rule-based correlation of an alert with an existing incident record, according to an example embodiment. Flowchart 300 may be implemented in system 100. For purposes of illustration, flowchart 300 is described with reference to FIG. 1. Other structural and operational embodiments will be apparent to persons skilled in the relevant art(s) based on the following discussion regarding flowchart 300 and FIG. 1.

Flowchart 300 of FIG. 3 begins with step 302. In step 302, information about a first alert is received. For example, rule-based correlation engine 130 may be configured to receive alert information 110 that may correspond to an alert received by processor(s) 102 from a monitoring system. The alert may be a newly received alert or an alert that has been recorded, for example, in database 140 or another memory location. As noted above, alert information 110 may comprise alert attributes (or alert metadata) such as an alert identifier (ID), a time associated with the alert, an ID associated with a source of the alert, a create date of the source, an owner of the source, a problem ID, an ID of a source device, an ID of a reporting device, an identifier of an environment or datacenter where a problem occurred, a root cause indication, an incident ID, a parent incident ID, a security impact indicator, a severity level, a customer ID, etc.

In step 304, an alert matching correlation rule may be retrieved based on the information about the first alert. For example, rule-based correlation engine 130 may be configured to retrieve one or more rules from correlation rules 134, which may be stored in memory 106 and/or remote storage 108, for example. In instances where correlation rules 134 are stored in memory 106, rule-based correlation engine 130 may be configured to perform in-memory rule matching which may reduce latency relative to rule-matching with correlation rules 134 stored in remote storage 108. Correlation rules 134 may indicate criteria for determining whether the received alert is correlated with an existing incident record stored in remote storage 108 (e.g., in database 140). Correlation rules 134 may be based on domain knowledge around the alert source system (e.g., cloud service system) or system 100, or any other suitable knowledge available to users. In some embodiments, a correlation rule may refer to information in data fields of a received alert (e.g., alert information 110) and/or of information related to an existing incident record. For example, the correlation rules may apply to attributes or metadata of received alert information 110 and/or information in existing incident records. Correlation rules may comprise data corresponding to, for example, a source environment type, a cloud instance ID, a tag embedded in an alert, an alert continuation indicator, dependency graphs, alert dependencies, host infrastructure dependencies, service dependencies, a correlation ID, a severity level, etc. Rule-based correlation engine 130 may be configured to compare alert information 110 to information related to correlation rules 134 and may find one or more of correlation rules 134 that are related to, or match, alert information 110 (e.g., a rule having information that best matches information of alert information 110).

In instances where no corresponding rule is found in correlation rules 134, incident manager 150 may be configured to create a new incident for the received alert based on alert information 110 and store the new incident in database 140 with existing incidents 142.

In some embodiments, cache memory 104 entries comprising query signatures 136 and existing incident record information 138 may comprise a key-value store or a key-value database (described in more detail above), where each query signature of query signatures 136 may function as a key to access a corresponding value comprising incident record information (e.g., an existing incident ID) for an existing incident record that may be stored in existing incident records 142 of database 140.

In some embodiments, in instances where no corresponding rule is found in correlation rules 134, machine-learning-based correlation engine 112 may be configured to perform machine-learning-based correlation to correlate the received alert with an existing incident record in existing incident records 142.

In step 306, a first correlation query may be constructed based on the information about the first alert and the alert matching correlation rule. For example, rule-based correlation engine 130 may be configured to construct a correlation query configured for querying database 140 for a correlated existing incident. The first query may be constructed utilizing alert information 110 of the received alert and/or information of the one or more correlation rules retrieved from correlation rules 134 for the received alert.

In step 308, a first query signature may be generated based on, at least, the first correlation query. For example, in some embodiments, rule-based correlation engine 130 may be configured to normalize (or standardize) the constructed first correlation query to conform to a specified format or a specified order of query elements. In some embodiments, rule-based correlation engine 130 may be configured to apply the normalized first correlation query to a hash algorithm (e.g., Secure Hash Algorithm (SHA)-1, SHA256, SHA348, SHA512, Advanced Encryption Standard (AES)-128, Rivest-Shamir-Adleman Cryptosystem (RSA)-2048, Elliptic Curve Cryptography (ECC)-P256). The resulting hash value may then serve as a query signature of the constructed first correlation query and may be utilized as a key for storing or accessing cache entries in cache memory 104. For example, the query signature may enable access to information related to an existing incident record (e.g., an incident record ID) in existing incident record information 138 stored in cache memory 104. However, the method is not limited to utilizing any specific type of query signature, and any suitable type of signature or key may be utilized as the query signature(s) to access cache entries in cache memory 104.

Cache memory 104 may store a plurality of cache entries, where each cache entry may include information related to, or identifying, a respective existing incident record of existing incident records 142. In some embodiments, the related information may have been retrieved from database 140 of remote storage 108. Each cache 104 entry may also include a respective query signature for retrieving the information related to the respective existing incident record from cache memory 104, the respective existing incident record being stored in database 140 in remote storage 108.

In step 310, a first cache entry may be identified in the cache based on the first query signature. For example, rule-based correlation engine 130 may be configured to search cache entries (e.g., query signatures 136) of cache memory 104 utilizing the first query signature that was generated based on the first correlation query, to identify a cache entry having a matching key or index in query signatures 136. Rule-based correlation engine 130 may be further configured to retrieve respective existing incident record information from existing incident record information 138.

In some embodiments, rule-based correlation engine 130 may be configured to call correlation cache service 132, which may comprise one or more application programming interfaces (API) to perform the search of the cache entries. For example, rule-based correlation engine 130 may identify the first cache entry in cache memory 104 based on the first query signature by providing the first query signature to correlation cache service 132, which searches cache memory 104 to find the first cache entry based on the first query signature, and returns the respective information related to the existing incident record. Correlation cache service 132 may be stored in memory 106 and executed by processor 102, or may be a remote cloud-based service called by processor 102.

In step 312, the first alert may be associated with an existing incident record about which related information is stored in the first cache entry. For example, in instances where rule-based correlation engine 130 finds a cache entry based on the first query signature, rule-based correlation engine 130 may be configured to determine that the received alert is correlated to an existing incident record of existing incident records 142, which is identified by the respective existing incident record information stored in the first cache entry of cache memory 104. Utilizing the cache memory 104 to identify correlated existing incident records greatly reduces the number of queries against remote storage 108 to achieve low latency, high availability, and high throughput on the correlation.

In step 314, an indication of the association between the first alert and the existing incident record about which the related information is stored in the first cache entry may be stored in the remote database. For example, incident manager 150 may be configured to store in memory (e.g., in database 140 of remote storage 108) an indication that the received alert corresponding to alert information 110 is correlated to the existing incident record (e.g., stored in database 140) that is identified by the existing incident record information stored in the first cache entry of cache memory 104. In other words, the corresponding existing incident record stored in database 140 may be identified as a parent incident of the first alert. In some embodiments, incident manager 150 may be configured to create a new incident record (or incident object) based on the received alert information 110. The new incident record may be linked as a child to the parent incident record (i.e., to the correlated existing incident record) to indicate the association between the first alert and the existing incident record.

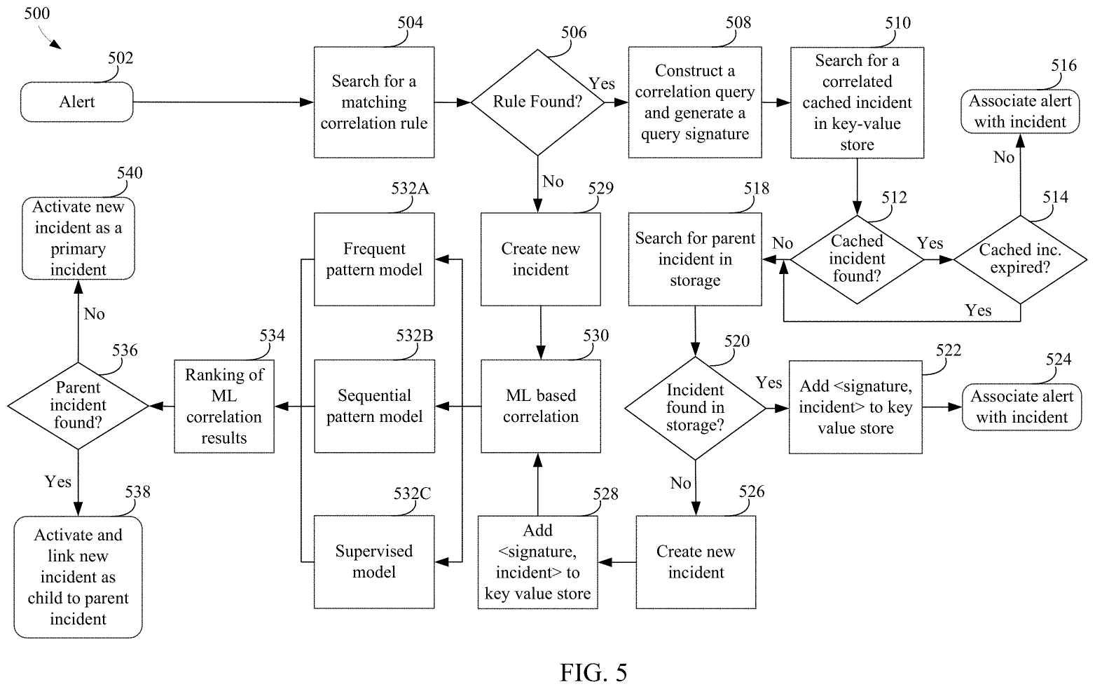

In instances where a cache entry is not found in cache memory 104 based on the first query signature (i.e., a cache miss), or where the validity time of a found cache entry has expired, incident manager 150 may be configured to utilize the first correlation query to search in database 140 of remote storage 108 for an existing incident record that is correlated to the received alert information 110. If the correlated existing incident record is found in database 140, it may be referred to as a parent incident relative to the received alert, or as a parent incident relative to the newly created incident record (e.g., where a new incident record was created based on the received alert information 110). Moreover, incident manager 150 may be configured to add the first query signature and information related to the correlated existing incident record found in database 140 as a cache entry in cache memory 104 within query signatures 136 and existing incident record information 138. See the description of FIG. 5 below for more information regarding handling of cache misses and/or expired cache entries.

In instances where a correlated existing incident record is not found via cache memory 104 entries or in database 140 of remote storage 108, a newly created incident record for received alert information 110 may be activated as a primary incident record and stored in database 140 of remote storage 108 as an existing incident record. Moreover, a query signature and incident record information related to the newly created incident record store in database 140 may be stored in cache memory 104 within query signatures 136 and existing incident record information 138 respectively.

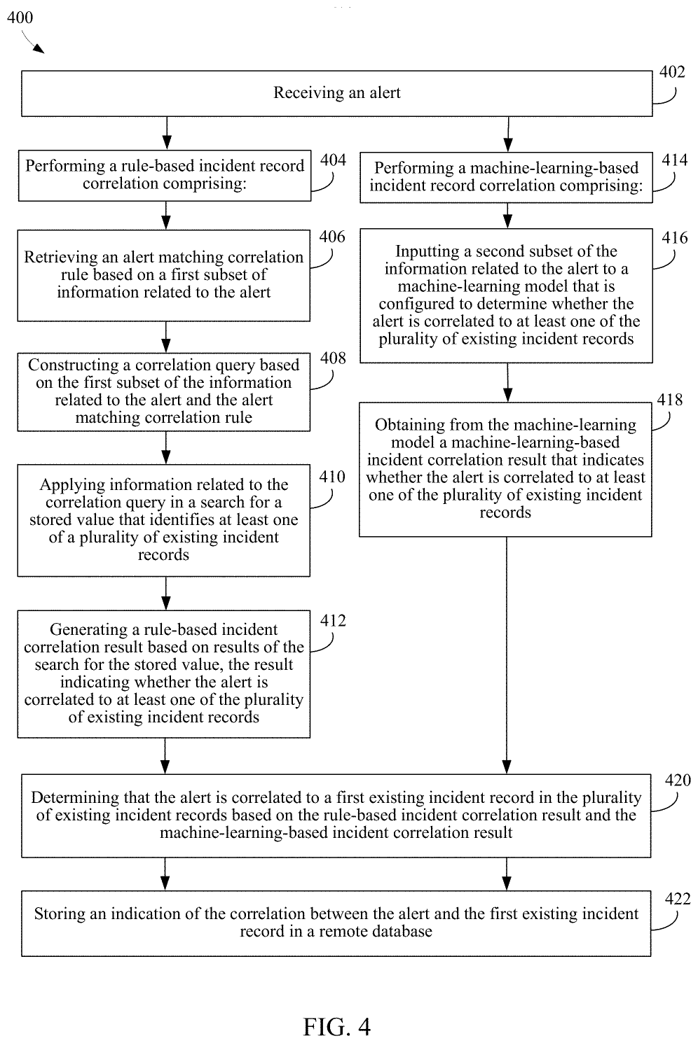

Rule-based correlation engine 130 and machine-learning based correlation engine 112 may be configured in various ways, and may operate in various ways, to perform these and further functions. For instance, FIG. 4 is a flowchart 400 of a method for correlating alert with an existing incident record utilizing a combination of rule-based and machine-learning-based correlation techniques, according to an example embodiment.

Flowchart 400 may be implemented in system 100. For purposes of illustration, flowchart 400 is described with reference to FIG. 1. Other structural and operational embodiments will be apparent to persons skilled in the relevant art(s) based on the following discussion regarding flowchart 400 and FIG. 1.

Although the numbered steps of flowchart 400 are ordered with steps pertaining to rule-based incident record correlation (e.g., steps 404-412) before steps pertaining to machine-learning-based incident record correlation (e.g., steps 414-418), the steps of flowchart 400 may be performed in a different order. For example, steps 404-412 may be performed before or after steps 414-418, performed concurrently and interleaved with steps 414-418, or performed concurrently and in parallel with steps 414-418, etc.). In some embodiments, performance of either of the steps pertaining to rule-based incident record correlation or the steps pertaining to machine-learning-based incident record correlation may yield a positive correlation result (e.g., where an alert is determined to be correlated to an existing incident record), or a negative correlation result (e.g., where the alert is not determined to be correlated with an existing incident record).

Flowchart 400 of FIG. 4 begins with step 402. In step 402, an alert is received. The alert may be a newly received alert and/or may be an alert that has been recorded in database 140 or another memory. For example, processor(s) 102 may be configured to receive an alert for an event that occurs in a monitored system (e.g., a source system). Machine-learning-based correlation engine 112 and/or rule-based correlation engine 130 may be configured to receive alert information 110 that may correspond to the alert received by processor(s) 102. As described above, alert information 110 may comprise alert attributes (or alert metadata).

Step 404 indicates that a rule-based incident record correlation may be performed as follows.

In step 406, an alert matching correlation rule may be retrieved based on a first subset of information related to the alert. The first subset of information related to the alert may comprise a first subset of information 110, which may comprise all or a portion of alert information 110. For example, as described above, rule-based correlation engine 130 may be configured to retrieve one or more rules from correlation rules 134, which may be stored in memory 106 (e.g., for in-memory rule matching) and/or remote storage 108. As described above, the correlation rules 134 may indicate criteria for determining whether the received alert having corresponding first subset of alert information 110 is correlated with an existing incident record of existing incident records 142. The criteria may be based on attributes or metadata of alert information 110. Rule-based correlation engine 130 may be configured to compare first subset of alert information 110 to information related to correlation rules 134 and may find one or more of correlation rules 134 that are related to, or match, the first subset of alert information 110. In some embodiments, incident manager 150 may be configured to create a new incident record for the received alert and store the new incident record in database 140 with existing incidents 142. Incident manager 150 may store a query signature and incident record information for the newly created incident in cache memory 104.

In step 408, a correlation query is constructed based on the first subset of the information related to the alert and the alert matching correlation rule. For example, rule-based correlation engine 130 may be configured to construct a correlation query configured for querying database 140 for a correlated existing incident. The correlation query may be constructed utilizing the first subset of alert information 110 of the received alert and/or information of the one or more correlation rules retrieved from correlation rules 134 for the received alert.

In step 410, information related to the correlation query is applied in a search for a stored value that identifies at least one of a plurality of existing incident records. For example, as described above, rule-based correlation engine 130 may be configured to normalize (or standardize) the constructed first correlation query to conform to a specified format or a specified order of query elements. In some embodiments, rule-based correlation engine 130 may be configured to apply the normalized first correlation query to a hash algorithm where the resulting hash value may serve as a query signature (or key) for storing or accessing information in cache memory 104 (e.g., incident record information 138). Rule-based correlation engine 130 may be configured to search cache entries (e.g., query signatures 136) of cache memory 104 utilizing the query signature to find a cache entry having a matching key and corresponding existing incident record information in the existing incident record information138.

In step 412, a rule-based correlation result is generated based on results of the search for the stored value, the result indicating whether the alert is correlated to at least one of the plurality of existing incident records. For example, in instances where rule-based correlation engine 130 finds a particular cache entry based on the query signature, rule-based correlation engine 130 may be configured to generate a rule-based correlation result indicating that the received alert, having a corresponding first subset of alert information 110, is correlated to at least one specified existing incident record of existing incident records 142. The correlated existing incident record(s) may be identified based on information (e.g., an incident record ID) stored in the particular cache entry (of incident record information 138). The correlated existing incident record(s) of the rule-based correlation result may be referred to as correlation candidate(s). In some embodiments, rule-based correlation engine 130 may generate a prediction confidence level for each correlated existing incident record(s).

Step 414 indicates that a machine-learning-based incident record correlation may be performed as follows.

In step 416, a second subset of the information related to the alert is input to a machine-learning model that is configured to determine whether the alert is correlated to at least one of the plurality of existing incident records (e.g., of existing incident records 142). The second subset of information related to the alert may comprise a second subset of alert information 110, which may comprise all or a portion of alert information 110. The second subset of alert information 110 may be the same, partially the same, or different than the first subset of alert information 110.

Machine-learning-based correlation engine 112 may be configured to input the second subset of alert information 110 to supervised machine-learning model(s) 114 and/or unsupervised machine learning model(s) 116 (e.g., frequent pattern model 118 and/or sequential pattern model 120), where each of the machine-learning models may be configured to determine whether the second subset of alert information 110 is correlated to an existing incident record of the plurality of existing incident records 142.

In step 418, a machine-learning-based correlation result that indicates whether the alert is correlated to at least one of the plurality of existing incident records is obtained from the machine-learning model. For example, in one embodiment, as described above with respect to flowchart 200, machine-learning-based correlation engine 112 may be configured to perform correlation of the received alert with one or more of the plurality of existing incident records 142 utilizing supervised machine-learning model(s) 114 and the second subset of alert information 110. Where one or more existing incident records of existing incident records 142 are correlated based on supervised machine-learning model(s) 114, the correlated one or more existing incident records (e.g., correlation candidates) may be referred to as a machine-learning-based correlation result. Alternatively, or in addition, as described above with respect to flowchart 200, machine-learning-based correlation engine 112 may be configured to perform correlation of the received alert with one or more of the plurality of existing incident records 142 utilizing unsupervised machine-learning model(s) 116 (e.g., frequent pattern model 118 and/or sequential pattern model 120) and the second subset of alert information 110. Where one or more existing incident records of existing incident records 142 are correlated with the second subset of alert information 110 based on unsupervised machine-learning model(s) 116, the correlated one or more existing incident records (e.g., correlation candidates) also may be referred to as a machine-learning-based correlation result.

In step 420, it may be determined that the alert is correlated to a first existing incident record in the plurality of existing incident records based on the rule-based correlation result and the machine-learning-based correlation result. For example, in one embodiment, ranking manager 152 may be configured to aggregate and rank the correlated existing incident record(s) (if any) of the machine-learning-based correlation result and the correlated existing incident record(s) (if any) of the rule-based correlation result. The ranking may be determined based on prediction confidence levels associated with respective correlation candidates of the rule-based correlation result and/or the machine-learning-based correlation result. In some embodiments, the ranking may be based on diverse criteria such as one or more of (i) a time difference between events (e.g., between an event of the alert and an event of an existing incident record), (ii) matching meta-data (e.g., same source cloud service identifiers, same engineer team name, same location (e.g., based on geo-location), (iii) model confidence scores, (iv) severity levels, (v) state of an incident. However, the criteria used for ranking correlation candidates is not limited to any specific criteria and any suitable criteria or criterion may be utilized. Ranking manager 152 may be configured to select a first correlated existing incident record in the plurality of existing incident records 142 based on the ranking of correlated existing incident records of the rule-based correlation result and/or the machine-learning-based correlation result. The first correlated existing incident record may be referred to as a parent incident record relative to the received alert.

In other embodiments, rather than ranking the rule-based correlation results and/or the machine-learning-based correlation results, ranking manager 152 may be configured to select the first correlated existing incident record based on a different type of criterion. In one example, the first correlated existing incident record may be selected based on which correlation candidates are determined first, or the order in which correlation candidates are determined.

In step 422, an indication of the correlation between the alert and the first existing incident record may be stored in a remote database. For example, incident manager 150 may be configured to store in memory (e.g., in database 140 of remote storage 108) an indication that the received alert having alert information 110 is correlated to the first existing incident record. In some embodiments, incident manager 150 may be configured to create a new incident record based on alert information 110 and the new incident may be linked as a child incident record to the parent incident record (i.e., to the correlated first existing incident record). In some embodiments, incident manager 150 may be configured to include information about similar or related incident records in the new incident record. For example, the similar or related incidents may comprise incidents from the correlation candidates of the rule-based correlation result and/or the machine-learning-based correlation result that ranked highly based on the prediction confidence levels. Having this additional information available in an incident record may support root cause discovery and/or improve time to incident mitigation. Alternatively, or in addition, for example where a correlated first existing incident record is not found, the newly created incident record may be activated as a primary incident record and stored in remote storage 108 as an existing incident record with existing incident records 142. Moreover, a query signature and incident record information for the newly created incident may be generated and stored in cache memory 104 with query signatures 136 and existing incident record information 138 respectively.

Once a correlation (or association) between an incoming alert and an existing incident record is determined (e.g., whether by rule-based correlation or machine-learning-based correlation), or an indication of such is stored in remote storage 108, the correlation (or association) may be conveyed via a user interface (UI) to a user (e.g., an engineer). Communicating this information via the UI allows the engineer to see the scope of an issue that may span multiple alerts and may reduce the efforts needed to find related existing incidents each time a new alert arrives. Moreover, by determining that an alert is not correlated with and existing incident record, and creating a new primary incident for the uncorrelated alert, an indication of the lack of correlation may also be conveyed via the UI to the user (e.g., engineer). In this manner the engineer will more quickly understand how to approach issue resolution.

System 100 may be configured, and may operate, in various ways to perform these and further functions. For instance, FIG. 5 is a flowchart 500 of an example method for correlating a received alert with an existing incident record utilizing rule-based or machine-learning based correlation techniques, according to an example embodiment. Flowchart 500 may be implemented in system 100. For purposes of illustration, flowchart 500 is described with reference to FIG. 1. Other structural and operational embodiments will be apparent to persons skilled in the relevant art(s) based on the following discussion regarding flowchart 500 and FIG. 1.

Flowchart 500 of FIG. 5 begins with step 502. In step 502, an alert is received. For example, processor(s) 102 may receive an alert and store information related to the alert as alert information 110 in memory 106.

In step 504, a search may be performed for finding a matching correlation rule. For example, rule-based correlation engine 130 may be configured to search in correlation rules 134 in memory 106 and/or remote storage 108 for a correlation rule that may comprise information matching information of alert information 110.

In step 506, in instances where a matching correlation rule is found, the method may proceed to step 508.

In step 508, a correlation query may be constructed, and a query signature may be generated based on the correlation query. For example, as described above, rule-based correlation engine 130 may be configured to construct a correlation query and generate a query signature based on a hash of a normalized, or standardized, version of the constructed correlation query. However, the example method is not limited with respect to any specific type of query signature, and any suitable signature or key may be utilized as the query signature.

In step 510, a search may be performed for finding cached information related to a correlated existing incident record in the key-value store. For example, query signatures 136 and existing incident record information 138 of cache memory 104 may comprise a key-value store. Rule-based correlation engine 130 may be configured to utilize the generated query signature as a key to find a cache entry in the key-value store, which stores existing incident record information related to an existing incident record stored in database 140, which is correlated to the received alert (or alert information 110). In some embodiments, the cached existing incident record information found with the query signature may comprise an identifier for the correlated existing incident record.

In step 512, in instances where the existing incident record information for the correlated existing incident record is found in cache 104, proceed to step 514.

In step 514, in instances where the existing incident record information for the correlated existing incident record in cache memory 104 has not yet expired, proceed to step 516. In some embodiments, existing incident record information stored in cache memory 104 (e.g., as query signatures 136 and/or existing incident record information 138) may expire based on different criteria. In one example, the validity of query signatures 136 and/or existing incident record information 138 may be determined according to:

expiration time=incident record creation time+correlation window

In other cases, a cache entry may be evicted early or extended based on events occurring in an external system such as an update to the cached incident that either disqualifies it from further correlation or broadens its eligibility scope as a candidate parent.

In step 516, the received alert may be associated with the correlated existing incident record. For example, incident manager 150 may be configured to store information indicating an association between the received alert and the correlated existing incident record (or the correlated cached existing incident record information) in remote storage 108, in memory 106, and/or in cache memory 104.

In step 512, in instances where the existing incident record information for the correlated existing incident record is not found in cache 104, proceed to step 518.

In step 514, in instances where the correlated cached incident has expired, proceed to step 518.

In step 518, a search may be performed to find a parent incident in storage. For example, incident manager 150 may be configured to utilize the constructed correlation query to search in database 140 of remote storage 108 for a correlated existing incident record. If the correlated existing incident is found in remote storage 108, it may be referred to as a parent incident relative to the received alert.

In step 520, in instances where a correlated existing incident record is found within the storage, proceed to step 522.

In step 522, the query signature and the information related to the correlated existing incident may be added to the key-value store. For example, incident manager 150 may be configured to store the query signature and the information related to the correlated existing incident (e.g., an ID of the correlated existing incident) as an entry in cache memory 104, within the key value store comprising query signatures 136 and existing incident record information 138.

In step 524, the received alert may be associated with the correlated existing incident record. For example, incident manager 150 may be configured to store information indicating an association between the received alert and the correlated existing incident record stored in remote storage 108 (or the correlated cached existing incident record information) in existing incident records 142 of remote storage 108, memory 106, and/or cache memory 104.

In step 520, in instances where a correlated existing incident record is not found within storage, proceed to step 526.

In step 526, a new incident record may be created for the received alert. For example, incident manager 150 may create a new incident record (or new incident object) comprising information at least based on alert information 110.

In step 528, the query signature and information related to the correlated existing incident record may be added to the key-value store. For example, incident manager 150 may be configured to store the query signature (e.g., key) and information related to the new incident record (e.g., value, such as an identifier of the new incident record) as a cache entry in cache memory 104 (e.g., within the key-value store comprising query signatures 136 and existing incident record information 138).

In step 506, in instances where a matching correlation rule is not found, the method may proceed to step 529.

In step 529, a new incident record may be created for the received alert. For example, as described with respect to step 526, incident manager 150 may create a new incident record (or new incident object) comprising information related to the new incident record based on, at least, alert information 110.

In step 530, machine-learning-based correlation may be performed for the received alert. For example, one or both of supervised machine learning model(s) 114 and unsupervised machine learning model(s) 116 may be configured to perform machine-learning-based correlation using alert information 110 of the received alert.

In steps 532A, 532B, and/or 532C, as described above with respect to flowchart 200 and flowchart 500, machine-learning based correlation engine 112 may be configured to perform the machine-learning based correlation of step 530 based on frequent pattern model 118 (for unsupervised learning), sequential pattern model 120 (for unsupervised learning), and/or supervised machine-learning model 114, and output machine-learning based correlation results comprising one or more correlation candidates that may correspond to one or more existing incident records of existing incident records 142 stored in database 140.

In step 534, results from the machine-learning based correlation may be ranked. For example, ranking manager 152 may be configured to aggregate and rank the one or more correlation candidates in the machine-learning based correlation results, and may select a first correlation candidate of the one or more correlation candidates as being correlated with the received alert. The selection may be based on confidence levels associated with each respective correlation candidate (e.g., prediction confidence levels). The first correlation candidate may correspond to a first existing incident record of the plurality of existing incident records 142 such that the received alert (or alert information 110) is correlated with the first existing incident record, which may be referred to as a parent incident record to the received alert.

In step 536, in instances when the parent incident record is found based on the machine-learning-based correlation results, the method may proceed to step 538.

In step 538, the newly created incident record may be activated and linked as a child incident to the parent incident record. For example, incident manager 150 may be configured to link the newly created incident record or object (e.g., of step 526 or 529) to the parent incident record of existing incident records 142, which corresponds to the selected first correlation candidate.

In step 536, in instances where the parent incident is not found based on the machine-learning-based correlation results, the method may proceed to step 540.

In step 540, the newly created incident record may be activated as a primary incident. For example, where machine-learning-based correlation engine 112 does not find a correlated existing incident, incident manager 150 may be configured to activate the newly created incident record or object (e.g., of step 526 or 529) as a primary incident and store the newly created incident record in database 140 in remote storage 108 as an existing incident record of existing incident records 142.

Two-layer correlation utilizing both rule-based correlation and machine-learning-based correlation provides reduced incident noise (avoiding duplicate notifications of new incidents) and reduces the cost for alert/incident storage for correlation purposes.

### III. Example Computer System Implementation

Embodiments described herein may be implemented in hardware, or hardware combined with software and/or firmware. For example, embodiments described herein may be implemented as computer program code/instructions configured to be executed in one or more processors and stored in a computer readable storage medium. Alternatively, embodiments described herein may be implemented as hardware logic/electrical circuitry.

As noted herein, the embodiments described, including but not limited to, system 100 along with any components and/or subcomponents thereof, as well any operations and portions of flowcharts/flow diagrams described herein and/or further examples described herein, may be implemented in hardware, or hardware with any combination of software and/or firmware, including being implemented as computer program code configured to be executed in one or more processors and stored in a computer readable storage medium, or being implemented as hardware logic/electrical circuitry, such as being implemented together in a system-on-chip (SOC), a field programmable gate array (FPGA), an application specific integrated circuit (ASIC), a trusted platform module (TPM), and/or the like. A SOC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

Embodiments described herein may be implemented in one or more computing devices similar to a mobile system and/or a computing device in stationary or mobile computer embodiments, including one or more features of mobile systems and/or computing devices described herein, as well as alternative features. The descriptions of computing devices provided herein are provided for purposes of illustration, and are not intended to be limiting. Embodiments may be implemented in further types of computer systems, as would be known to persons skilled in the relevant art(s).

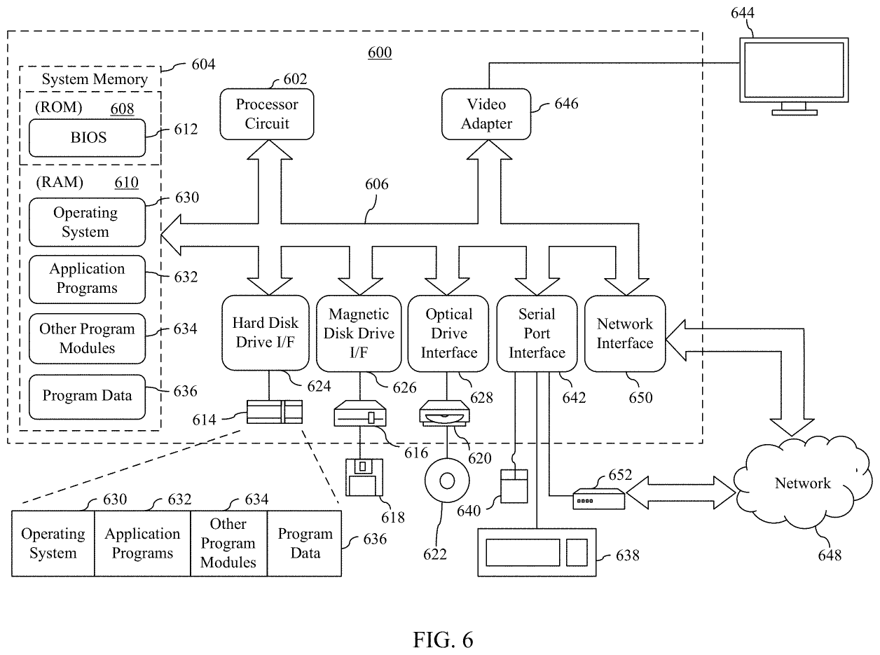

FIG. 6 is a block diagram of an example processor-based computer system 1000 that may be used to implement various embodiments. System 100 may include any type of computing device, mobile or stationary, such as a desktop computer, a server, a video game console, etc. For example, system 100 may comprise any type of mobile computing device (e.g., a Microsoft® Surface® device, a personal digital assistant (PDA), a laptop computer, a notebook computer, a tablet computer such as an Apple iPad™, a netbook, etc.), a mobile phone (e.g., a cell phone, a smart phone such as a Microsoft Windows® phone, an Apple iPhone, a phone implementing the Google® Android™operating system, etc.), a wearable computing device (e.g., a head-mounted device including smart glasses such as Google® Glass™, Oculus Rift® by Oculus VR, LLC, etc.), a stationary computing device such as a desktop computer or PC (personal computer), a gaming console/system (e.g., Microsoft Xbox®, Sony PlayStation®, Nintendo Wii® or Switch®, etc.), etc.

System 100 may be implemented in one or more computing devices containing features similar to those of computing device 600 in stationary or mobile computer embodiments and/or alternative features. The description of computing device 600 provided herein is provided for purposes of illustration, and is not intended to be limiting. Embodiments may be implemented in further types of computer systems, as would be known to persons skilled in the relevant art(s).

As shown in FIG. 6, computing device 600 includes one or more processors, referred to as processor circuit 602, a system memory 604, and a bus 606 that couples various system components including system memory 604 to processor circuit 602. Processor circuit 602 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 602 may execute program code stored in a computer readable medium, such as program code of operating system 630, application programs 632, other programs 634, etc. Bus 606 represents one or more of any of several types of bus structures, including a memory bus or memory controller, a peripheral bus, an accelerated graphics port, and a processor or local bus using any of a variety of bus architectures. System memory 604 includes read only memory (ROM) 608 and random-access memory (RAM) 610. A basic input/output system 612 (BIOS) is stored in ROM 608.

Computing device 600 also has one or more of the following drives: a hard disk drive 614 for reading from and writing to a hard disk, a magnetic disk drive 616 for reading from or writing to a removable magnetic disk 618, and an optical disk drive 620 for reading from or writing to a removable optical disk 622 such as a CD ROM, DVD ROM, or other optical media. Hard disk drive 614, magnetic disk drive 616, and optical disk drive 620 are connected to bus 606 by a hard disk drive interface 624, a magnetic disk drive interface 626, and an optical drive interface 628, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 630, one or more application programs 632, other programs 634, and program data 636. Application programs 632 or other programs 634 may include, for example, computer program logic (e.g., computer program code or instructions) for implementing processor(s) 102, cache memory 104, memory 106, remote storage 108, machine-learning-based correlation engine 112, supervised machine learning models 114, unsupervised machine learning models 116, frequent pattern model 118, sequential pattern model 120, rules based correlation engine 130, correlation cache service 132, incident manager 150, ranking manager 152, database 140, and any one or more of flowcharts 200, 300, 400, and 500 (including any step thereof), and/or further embodiments described herein. Program data 636 may include alert information 110, correlation rules 134, query signatures 136, incident record information 138, existing incident records 142, encryption keys, authorization data, and/or further embodiments described herein.

A user may enter commands and information into computing device 600 through input devices such as keyboard 638 and pointing device 640. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 602 through a serial port interface 642 that is coupled to bus 606, but may be connected by other interfaces, such as a parallel port, game port, or a universal serial bus (USB).

A display screen 644 is also connected to bus 606 via an interface, such as a video adapter 646. Display screen 644 may be external to, or incorporated in computing device 600. Display screen 644 may display information, as well as being a user interface for receiving user commands and/or other information (e.g., by touch, finger gestures, virtual keyboard, etc.). In addition to display screen 644, computing device 600 may include other peripheral output devices (not shown) such as speakers and printers.

Computing device 600 is connected to a network 648 (e.g., the Internet) through an adaptor or network interface 650, a modem 652, or other means for establishing communications over the network. Modem 652, which may be internal or external, may be connected to bus 606 via serial port interface 642, as shown in FIG. 6, or may be connected to bus 606 using another interface type, including a parallel interface.

As used herein, the terms “computer program medium,” “computer-readable medium,” and “computer-readable storage medium” are used to refer to physical hardware media such as the hard disk associated with hard disk drive 614, removable magnetic disk 618, removable optical disk 622, other physical hardware media such as RAMs, ROMs, flash memory cards, digital video disks, zip disks, MEMs, nanotechnology-based storage devices, and further types of physical/tangible hardware storage media. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 632 and other programs 634) may be stored on the hard disk, magnetic disk, optical disk, ROM, RAM, or other hardware storage medium. Such computer programs may also be received via network interface 650, serial port interface 642, or any other interface type. Such computer programs, when executed or loaded by an application, enable computing device 600 to implement features of embodiments discussed herein. Accordingly, such computer programs represent controllers of computing device 600.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

### IV. Additional Example Embodiments

In an embodiment, a system for correlating an event with an existing event record based on machine-learning correlation models comprises one or more processors, event memory storing information related to a plurality of existing event records, and one or more memory devices. The one or more memory devices stores program code to be executed by the one or more processors. The program code comprises a machine-learning-based correlation engine configured to receive information related to the event and input the information related to the event to one or more machine-learning models. Each of the one or more machine-learning models is configured to determine whether the event is correlated to an existing event record of the plurality of existing event records. Based on output from each of the one or more machine-learning models, a machine-learning-based correlation result is generated, which indicates that a correlation exists between the event and a first existing event record of the plurality of existing event records. Based at least on the machine-learning-based correlation result, information is stored in the event memory indicating that the event is correlated to the first existing event record.

In an embodiment of the foregoing system, each of the one or more machine-learning models is based on at least one of a supervised model and an unsupervised model.

In an embodiment of the foregoing system, the machine-learning based correlation result is generated based on a ranking of output from each of the one or more machine-learning models.

In an embodiment of the foregoing system, the event comprises an alert and the plurality of existing event records comprise a plurality of existing incident records, the information related to the event is obtained from a first alert record and the plurality of existing event records comprise a plurality of existing alert records, or the information related to the event is obtained from a first incident record and the plurality of existing event records comprise a plurality of existing incident records.

In an embodiment of the foregoing system, at least one of the following occurs: correlation of the event to the existing event record is triggered by a new event, and correlation of an event to the existing event record of the plurality of existing event records is repeated over time.

In an embodiment of the foregoing system, the information related to the event is enriched between a first correlation of the event and a second correlation of the event.

In an embodiment of the foregoing system, the machine-learning-based correlation engine is further configured to, at least one of: (1) retrieve a frequent pattern model prediction for the event, determine first patterns for the event based on the frequent pattern model prediction, perform a first search of the event memory for matching frequent patterns in the plurality of existing event records, and return a first list of possible event records correlated to the event from the plurality of existing event records in response the first search, (2) retrieve a sequential pattern model prediction for the event, determine second patterns for the event based on the sequential pattern model prediction, perform a second search of the of the event memory for matching sequential patterns in the plurality of existing event records, and return a second list of possible event records correlated to the event from the plurality of existing event records in response to the second search, or (3) retrieve a supervised model prediction for the event, and retrieve, from the event memory, a third list of possible event records correlated to the event from the plurality of existing event records based on the supervised model prediction. The program code further comprises a ranking manager configured to aggregate, rank, and validate the possible event records correlated to the event from at least one of the first list, the second list, and the third list to perform said generate a machine-learning-based correlation result indicating that a correlation exists between the event and a first existing event record of the plurality of existing event records.

In an embodiment, a system for correlating an event with an existing event record comprises one or more processors and memory local to the one or more processors. The local memory comprises a cache that stores a plurality of cache entries. Each cache entry in the plurality of cache entries includes (i) information related to a respective existing event record wherein the related information is retrieved from a database remote to the one or more processors, and (ii) a respective signature of a correlation query for retrieving the information related to the respective existing event record from the remote database. The local memory further comprises program code comprising a rule-based correlation engine. The rule-based correlation engine is configured to receive information about a first event and retrieve an event matching correlation rule based on the information about the first event. The rule-based correlation engine is further configured to construct a first correlation query based on the information about the first event and the event matching correlation rule, generate a first signature based at least on the first correlation query, identify a first cache entry in the cache based on the first signature, associate the first event with an existing event record about which related information is stored in the first cache entry, and store an indication of the association between the first event and the existing event record about which the related information is stored in the first cache entry in the remote database.

In an embodiment of the foregoing system, the first event comprises an alert and the existing event record comprises an existing incident record, receiving the information about the first event comprises receiving information obtained from a first alert record and the existing event record comprises an existing alert record, or receiving the information about the first event comprises receiving information obtained from a first incident record and existing event record comprises an existing incident record.

In an embodiment of the foregoing system, each of the plurality of cache entries expires based on a correlation window and a respective creation time related to each of the cache entries.

In an embodiment of the foregoing system, a plurality of correlation rules for use by the rule-based correlation engine are stored in a main memory of the at least one of the one or more processors, and the retrieved event matching correlation rule is retrieved from the main memory from the plurality of correlation rules.

In an embodiment of the foregoing system, the rule-based correlation engine is further configured to: store a cache entry in the cache that includes (i) information related to the existing event record identified in response to the remote database query, and (ii) the second signature.

In an embodiment of the foregoing system, the rule-based correlation engine is further configured to normalize a format of the first correlation query and the first signature is generated based on a hash of the normalized first correlation query.

In an embodiment of the foregoing system, the memory local to the one or more processors further comprises a main memory storing a plurality of event matching correlation rules and the retrieved event matching correlation rule is retrieved from the main memory.

In an embodiment a method for correlating an event with an existing event record comprises performing a rule-based event record correlation. The rule-based event record correlation comprises retrieving an event matching correlation rule based on a first subset of information related to the event, constructing a correlation query based on the first subset of the information related to the event and the event matching correlation rule, and applying information related to the correlation query in a search for a stored value that identifies at least one of a plurality of existing event records. The rule-based event record correlation further comprises generating a rule-based correlation result based on results of the search for the stored value, where the result indicates whether the event is correlated to at least one of the plurality of existing event records. The method further comprises performing a machine-learning-based event record correlation. The machine-learning-based event record correlation comprises inputting a second subset of the information related to the event to a machine-learning model that is configured to determine whether the event is correlated to at least one of the plurality of existing event records, and obtaining from the machine-learning model a machine-learning-based correlation result that indicates whether the event is correlated to at least one of the plurality of existing event records. The method further comprises determining that the event is correlated to a first existing event record in the plurality of existing event records based on the rule-based correlation result and the machine-learning-based correlation result, and storing an indication of the correlation between the event and the first existing event record in a remote database.

In an embodiment of the foregoing method, the rule-based event record correlation is performed before the machine-learning-based event record correlation, after the machine-learning-based event record correlation, or concurrent with the machine-learning-based event record correlation.

In an embodiment of the foregoing method, the retrieved event matching correlation rule is retrieved from a main memory of a processor performing the event matching correlation rule retrieval.

In an embodiment of the foregoing method, the search for the stored value that identifies at least one of the plurality of existing event records includes at least one of: utilizing a signature of the correlation query to search a cache memory local to a processor performing the search, or applying the correlation query to the remote database.

In an embodiment of the foregoing method, the machine-learning model is based on at least one of a supervised model and an unsupervised model.

In an embodiment of the foregoing method, a new event record is created based on the event in response to not finding a correlated existing event record utilizing the rule-based event record correlation or the machine-learning-based event record correlation, and information related to the new event is stored as a primary event record in association with the information related to the correlation query in the remote database.

### VI. Conclusion

While various embodiments of the present disclosed subject matter have been described above, it should be understood that they have been presented by way of example only, and not limitation. It will be understood by those skilled in the relevant art(s) that various changes in form and details may be made therein without departing from the spirit and scope of the disclosed subject matter as defined in the appended claims. Accordingly, the breadth and scope of the disclosed subject matter should not be limited by any of the above-described exemplary embodiments, but should be defined only in accordance with the following claims and their equivalents.

What is claimed is:

1. A system for correlating an event with an existing event record based on machine-learning correlation models, the system comprising:
one or more processors;
event memory storing information related to a plurality of existing event records;
one or more memory devices, the one or more memory devices storing program code to be executed by the one or more processors, the program code comprising:
a machine-learning-based correlation engine configured to:
receive information related to the event;
input the information related to the event to one or more machine-learning models, wherein each of the one or more machine-learning models is configured to determine whether the event is correlated to an existing event record of the plurality of existing event records;
based on output from each of the one or more machine-learning models, generate a machine-learning-based correlation result indicating that a correlation exists between the event and a first existing event record of the plurality of existing event records; and
based at least on the machine-learning-based correlation result, store information in the event memory indicating that the event is correlated to the first existing event record.

2. The system of claim 1, wherein each of the one or more machine-learning models is based on at least one of a supervised model and an unsupervised model.

3. The system of claim 1, wherein the machine-learning based correlation result is generated based on a ranking of output from each of the one or more machine-learning models.

4. The system of claim 1, wherein:
the event comprises an alert and the plurality of existing event records comprise a plurality of existing incident records;
the information related to the event is obtained from a first alert record and the plurality of existing event records comprise a plurality of existing alert records; or
the information related to the event is obtained from a first incident record and the plurality of existing event records comprise a plurality of existing incident records.

5. The system of claim 1, wherein at least one of the following occurs:
correlation of the event to the existing event record is triggered by a new event; and
correlation of an event to the existing event record of the plurality of existing event records is repeated over time.

6. The system of claim 5, wherein the information related to the event is enriched between a first correlation of the event and a second correlation of the event.

7. The system of claim 1, wherein the machine-learning-based correlation engine is further configured to:
at least one of:
(i) retrieve a frequent pattern model prediction for the event;
determine first patterns for the event based on the frequent pattern model prediction;
perform a first search of the event memory for matching frequent patterns in the plurality of existing event records; and
return a first list of possible event records correlated to the event from the plurality of existing event records in response the first search;
(ii) retrieve a sequential pattern model prediction for the event;
determine second patterns for the event based on the sequential pattern model prediction;
perform a second search of the of the event memory for matching sequential patterns in the plurality of existing event records; and
return a second list of possible event records correlated to the event from the plurality of existing event records in response to the second search; or
(iii) retrieve a supervised model prediction for the event; and
retrieve, from the event memory, a third list of possible event records correlated to the event from the plurality of existing event records based on the supervised model prediction;
the program code further comprising a ranking manager configured to:
aggregate, rank, and validate the possible event records correlated to the event from at least one of the first list, the second list, and the third list to perform said generate a machine-learning-based correlation result indicating that a correlation exists between the event and a first existing event record of the plurality of existing event records.

8. A system for correlating an event with an existing event record, the system comprising:
one or more processors;
memory local to the one or more processors, the local memory comprising:
a cache storing a plurality of cache entries, each cache entry in the plurality of cache entries including (i) information related to a respective existing event record wherein the related information is retrieved from a database remote to the one or more processors, and (ii) a respective signature of a correlation query for retrieving the information related to the respective existing event record from the remote database; and
program code comprising:
a rule-based correlation engine configured to:
receive information about a first event;
retrieve an event matching correlation rule based on the information about the first event;
construct a first correlation query based on the information about the first event and the event matching correlation rule;
generate a first signature based at least on the first correlation query;
identify a first cache entry in the cache based on the first signature;
associate the first event with an existing event record about which related information is stored in the first cache entry; and
store an indication of the association between the first event and the existing event record about which the related information is stored in the first cache entry in the remote database.

9. The system of claim 8, wherein:
the first event comprises an alert and the existing event record comprises an existing incident record;
receiving the information about the first event comprises receiving information obtained from a first alert record and the existing event record comprises an existing alert record; or receiving the information about the first event comprises receiving information obtained from a first incident record and existing event record comprises an existing incident record.

10. The system of claim 8, wherein each of the plurality of cache entries expires based on a correlation window and a respective creation time related to each of the cache entries.

11. The system of claim 8, wherein:
a plurality of correlation rules for use by the rule-based correlation engine are stored in a main memory of the at least one of the one or more processors; and
the retrieved event matching correlation rule is retrieved from the main memory from the plurality of correlation rules.

12. The system of claim 11, wherein the rule-based correlation engine is further configured to:
store a cache entry in the cache that includes (i) information related to the existing event record identified in response to the remote database query, and (ii) the second signature.

13. The system of claim 8, wherein the rule-based correlation engine is further configured to normalize a format of the first correlation query and the first signature is generated based on a hash of the normalized first correlation query.

14. The system of claim 8, wherein the memory local to the one or more processors further comprises a main memory storing a plurality of event matching correlation rules and the retrieved event matching correlation rule is retrieved from the main memory.

15. A method for correlating an event with an existing event record, the method comprising:
performing a rule-based event record correlation comprising:
retrieving an event matching correlation rule based on a first subset of information related to the event;
constructing a correlation query based on the first subset of the information related to the event and the event matching correlation rule;
applying information related to the correlation query in a search for a stored value that identifies at least one of a plurality of existing event records; and
generating a rule-based correlation result based on results of the search for the stored value, wherein the result indicates whether the event is correlated to at least one of the plurality of existing event records;
performing a machine-learning-based event record correlation comprising:
inputting a second subset of the information related to the event to a machine-learning model that is configured to determine whether the event is correlated to at least one of the plurality of existing event records; and
obtaining from the machine-learning model a machine-learning-based correlation result that indicates whether the event is correlated to at least one of the plurality of existing event records;
determining that the event is correlated to a first existing event record in the plurality of existing event records based on the rule-based correlation result and the machine-learning-based correlation result; and
storing an indication of the correlation between the event and the first existing event record in a remote database.

16. The method of claim 15, wherein the rule-based event record correlation is performed before the machine-learning-based event record correlation, after the machine-learning-based event record correlation, or concurrent with the machine-learning-based event record correlation.

17. The method of claim 15, wherein the retrieved event matching correlation rule is retrieved from a main memory of a processor performing the event matching correlation rule retrieval.

18. The method of claim 15, wherein the search for the stored value that identifies at least one of the plurality of existing event records includes at least one of:
utilizing a signature of the correlation query to search a cache memory local to a processor performing the search, or
applying the correlation query to the remote database.

19. The method of claim 15, wherein the machine-learning model is based on at least one of a supervised model and an unsupervised model.

20. The method of claim 15, further comprising:
creating a new event record based on the event in response to not finding a correlated existing event record utilizing the rule-based event record correlation or the machine-learning-based event record correlation; and
storing information related to the new event as a primary event record in association with the information related to the correlation query in the remote database
